(19) United States
(12) Patent Application Publication
(10) Pub. No.: US 2011/0244817 A1
(43) Pub. Date: Oct. 6, 2011

(54) FORWARD LINK SIGNALING

(75) Inventor: Zhen Ning Low, La Jolla, CA (US)

(73) Assignee: QUALCOMM INCORPORATED, San Diego, CA (US)

(21) Appl. No.: 12/905,953

(22) Filed: Oct. 15, 2010

Related U.S. Application Data
(60) Provisional application No. 61/321,401, filed on Apr. 6, 2010.

(51) Int. Cl. H04B 1/04

(52) U.S. Cl. 455/108; 455/121

(57) ABSTRACT

Exemplary embodiments are directed to forward link signaling via transmitter detuning A method may include selectively detuning a circuit to adjust an amplitude of an associated transmit signal based on data to be transmitted. The method may also include selectively retuning the circuit to differently adjust the amplitude of the transmit signal based on the data to be transmitted.

### CLAIM OF PRIORITY UNDER 35 U.S.C. §119

This application claims priority under 35 U.S.C. §119(e) to:

U.S. Provisional Patent Application 61/321,401 entitled “FORWARD LINK SIGNALING VIA TRANSMITTER DETUNING” filed on Apr. 6, 2010, the disclosure of which is hereby incorporated by reference in its entirety.

### BACKGROUND

1. Field

The present invention relates generally to forward link signaling, and more specifically, to systems, device, and methods for detuning and tuning a transmitter for forward link signaling.

2. Background

Approaches are being developed that use over the air power transmission between a transmitter and the device to be charged. These generally fall into two categories. One is based on the coupling of plane wave radiation (also called far-field radiation) between a transmit antenna and receive antenna on the device to be charged which collects the radiated power and rectifies it for charging the battery. Antennas are generally of resonant length in order to improve the coupling efficiency. This approach suffers from the fact that the power coupling falls off quickly with distance between the antennas. So charging over reasonable distances (e.g., >1-2 m) becomes difficult. Additionally, since the system radiates plane waves, unintentional radiation can interfere with other systems if not properly controlled through filtering.

Other approaches are based on inductive coupling between a transmit antenna embedded, for example, in a “charging” mat or surface and a receive antenna plus rectifying circuit embedded in the host device to be charged. This approach has the disadvantage that the spacing between transmit and receive antennas must be very close (e.g. mms). Though this approach does have the capability to simultaneously charge multiple devices in the same area, this area is typically small, hence the user must locate the devices to a specific area.

As will be understood by a person having ordinary skill in the art, a first device, such as a wireless power transmitter, may communicate with one or more other devices, such as a wireless power receiver. This communication may be referred to as “forward link signaling.” Conventional forward link signaling methods may utilize a power converter, such as a buck converter, to adjust (i.e., decrease and/or or increase) an amplitude of a transmitted signal. Furthermore, circuitry within a receiver may be configured to identify received energy fluctuations, which may correspond to informational signaling from the transmitter. Conventional forward link signaling methods may be costly, and, because a power converter, such as a buck converter, may be slow to respond to desired power changes, the speed of forward link signaling may be limited.

A need exists to enhance forward link signaling. More, specifically, a need exists for systems, device, and methods to enhance forward link signaling by detuning a transmitter.

### BRIEF DESCRIPTION OF THE DRAWINGS

FIG. 1 shows a simplified block diagram of a wireless power transfer system.

FIG. 2 shows a simplified schematic diagram of a wireless power transfer system.

FIG. 3 illustrates a schematic diagram of a loop antenna for use in exemplary embodiments of the present invention.

FIG. 4 is a simplified block diagram of a transmitter, in accordance with an exemplary embodiment of the present invention.

FIG. 5 illustrates a portion of a transmitter including a detuning circuit, in accordance with an exemplary embodiment of the present invention.

FIG. 6 illustrates a portion of another transmitter including a detuning circuit, according to an exemplary embodiment of the present invention.

FIG. 7 illustrates a circuit including a filter and a detuning component, according to an exemplary embodiment of the present invention.

FIG. 8 illustrates the circuit of FIG. 7 during one stage of operation, in accordance with an exemplary embodiment of the present invention.

FIG. 9 illustrates the circuit of FIG. 7 during another stage of operation, in accordance with an exemplary embodiment of the present invention.

FIG. 10 illustrates a response of the circuit of FIG. 7, according to an exemplary embodiment of the present invention.

FIG. 11 illustrates another response of the circuit of FIG. 7, in accordance with an exemplary embodiment of the present invention.

FIG. 12 illustrates yet another response of the circuit of FIG. 7, according to an exemplary embodiment of the present invention.

FIG. 13 illustrates another circuit including a filter and a detuning component, according to an exemplary embodiment of the present invention.

FIG. 14 illustrates the circuit of FIG. 13 during one stage of operation, in accordance with an exemplary embodiment of the present invention.

FIG. 15 illustrates the circuit of FIG. 13 during another stage of operation, in accordance with an exemplary embodiment of the present invention.

FIG. 16 is a flowchart illustrating a method, in accordance with an exemplary embodiment of the present invention.

FIG. 17 is a flowchart illustrating another method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The words “wireless power” is used herein to mean any form of energy associated with electric fields, magnetic fields, electromagnetic fields, or otherwise that is transmitted between a transmitter to a receiver without the use of physical electrical conductors.

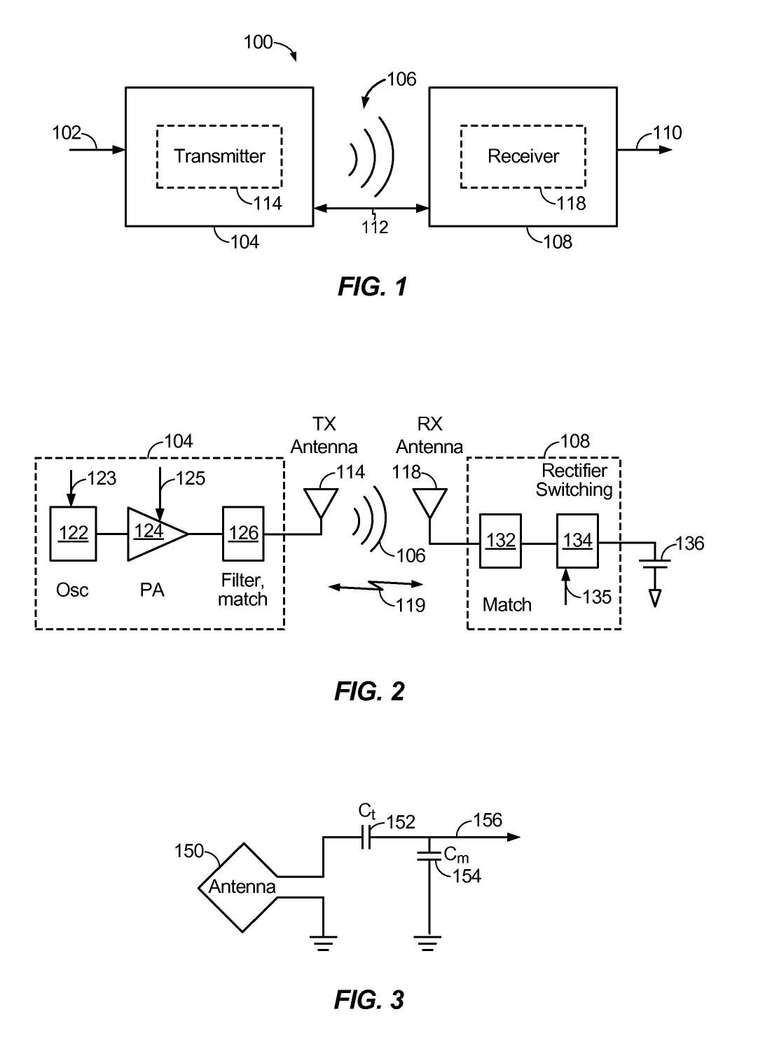

FIG. 1 illustrates a wireless transmission or charging system 100, in accordance with various exemplary embodiments of the present invention. Input power 102 is provided to a transmitter 104 for generating a radiated field 106 for providing energy transfer. A receiver 108 couples to the radiated field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the radiated field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

FIG. 2 shows a simplified schematic diagram of a wireless power transfer system. The transmitter 104 includes an oscillator 122, a power amplifier 124 and a filter and matching circuit 126. The oscillator is configured to generate a signal at a desired frequency, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114.

The receiver 108 may include a matching circuit 132 and a rectifier and switching circuit 134 to generate a DC power output to charge a battery 136 as shown in FIG. 2 or power a device coupled to the receiver (not shown). The matching circuit 132 may be included to match the impedance of the receiver 108 to the receive antenna 118. The receiver 108 and transmitter 104 may communicate on a separate communication channel 119 (e.g., Bluetooth, zigbee, cellular, etc).

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the near-field of the transmitting antenna to the receiving antenna residing in the neighborhood where this near-field is established rather than propagating the energy from the transmitting antenna into free space.

The resonant frequency of the loop or magnetic antennas is based on the inductance and capacitance. Inductance in a loop antenna is generally simply the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

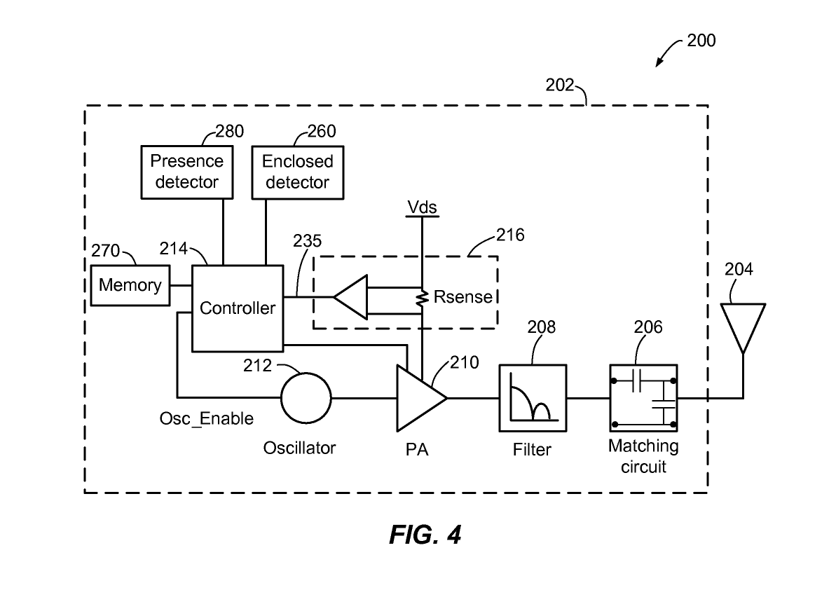

FIG. 4 is a simplified block diagram of a transmitter 200, in accordance with an exemplary embodiment of the present invention. The transmitter 200 includes transmit circuitry 202 and a transmit antenna 204. Generally, transmit circuitry 202 provides RF power to the transmit antenna 204 by providing an oscillating signal resulting in generation of near-field energy about the transmit antenna 204. It is noted that transmitter 200 may operate at any suitable frequency. By way of example, transmitter 200 may operate at the 13.56 MHz ISM band.

Exemplary transmit circuitry 202 includes a fixed impedance matching circuit 206 for matching the impedance of the transmit circuitry 202 (e.g., 50 ohms) to the transmit antenna 204 and a low pass filter (LPF) 208 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that can be varied based on measurable transmit metrics, such as output power to the antenna or DC current drawn by the power amplifier. Transmit circuitry 202 further includes a power amplifier 210 configured to drive an RF signal as determined by an oscillator 212. The transmit circuitry may be comprised of discrete devices or circuits, or alternately, may be comprised of an integrated assembly. An exemplary RF power output from transmit antenna 204 may be on the order of 2.5 Watts.

Transmit circuitry 202 further includes a controller 214 for enabling the oscillator 212 during transmit phases (or duty cycles) for specific receivers, for adjusting the frequency or phase of the oscillator, and for adjusting the output power level for implementing a communication protocol for interacting with neighboring devices through their attached receivers. As is well known in the art, adjustment of oscillator phase and related circuitry in the transmission path allows for reduction of out of band emissions, especially when transitioning from one frequency to another.

The transmit circuitry 202 may further include a load sensing circuit 216 for detecting the presence or absence of active receivers in the vicinity of the near-field generated by transmit antenna 204. By way of example, a load sensing circuit 216 monitors the current flowing to the power amplifier 210, which is affected by the presence or absence of active receivers in the vicinity of the near-field generated by transmit antenna 204. Detection of changes to the loading on the power amplifier 210 are monitored by controller 214 for use in determining whether to enable the oscillator 212 for transmitting energy and to communicate with an active receiver.

Transmit antenna 204 may be implemented with a Litz wire or as an antenna strip with the thickness, width and metal type selected to keep resistive losses low. In a conventional implementation, the transmit antenna 204 can generally be configured for association with a larger structure such as a table, mat, lamp or other less portable configuration. Accordingly, the transmit antenna 204 generally will not need “turns” in order to be of a practical dimension. An exemplary implementation of a transmit antenna 204 may be “electrically small” (i.e., fraction of the wavelength) and tuned to resonate at lower usable frequencies by using capacitors to define the resonant frequency. In an exemplary application where the transmit antenna 204 may be larger in diameter, or length of side if a square loop, (e.g., 0.50 meters) relative to the receive antenna, the transmit antenna 204 will not necessarily need a large number of turns to obtain a reasonable capacitance.

The transmitter 200 may gather and track information about the whereabouts and status of receiver devices that may be associated with the transmitter 200. Thus, the transmitter circuitry 202 may include a presence detector 280, an enclosed detector 290, or a combination thereof, connected to the controller 214 (also referred to as a processor herein). The controller 214 may adjust an amount of power delivered by the amplifier 210 in response to presence signals from the presence detector 280 and the enclosed detector 290. The transmitter may receive power through a number of power sources, such as, for example, an AC-DC converter (not shown) to convert conventional AC power present in a building, a DC-DC converter (not shown) to convert a conventional DC power source to a voltage suitable for the transmitter 200, or directly from a conventional DC power source (not shown).

Various exemplary embodiments of the present invention, as described herein, relate to systems, devices, and methods for forward link signaling. More specifically, various exemplary embodiments described herein include methods, systems, and devices for signaling from a transmitter to a receiver by detuning a transmitter, tuning a transmitter, or a combination thereof. As described more fully below, detuning may be performed at a transmitting coil, within transmit circuitry, or at an interface between the transmitting coil and associated transmit circuitry. Furthermore, as also described below, detuning may be achieved by either series switching or shunt switching a reactive element (e.g., a capacitor) to reduce output power of a transmitter. Although various exemplary embodiments disclosed herein are described in the context of a wireless power system, the embodiments of the present invention are not so limited. Rather, the embodiments of the present invention may be implemented within any suitable electronic system.

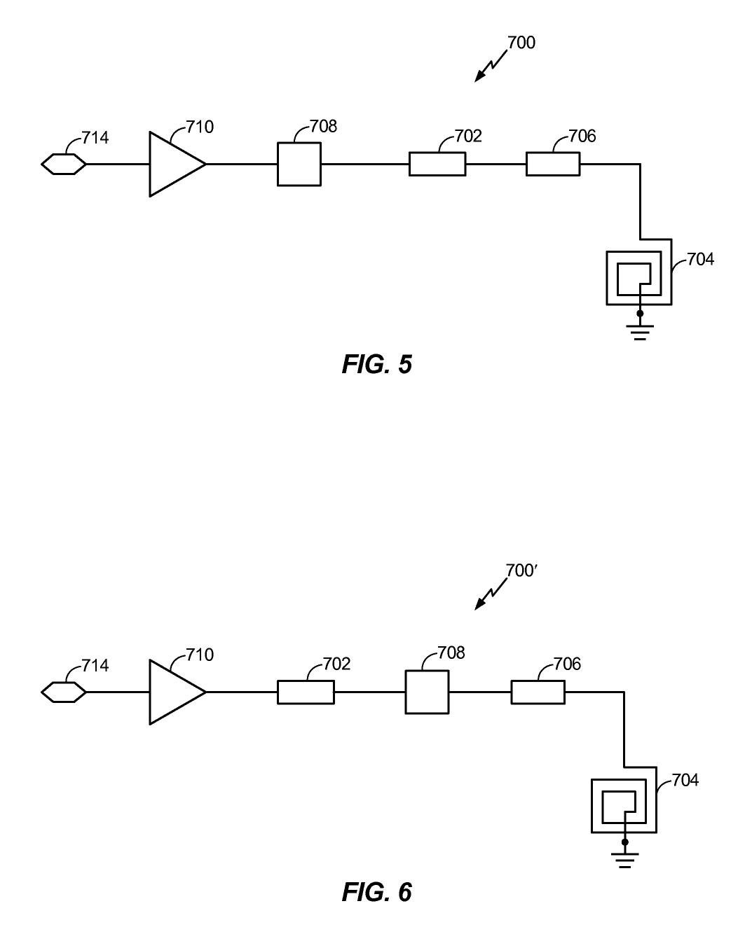

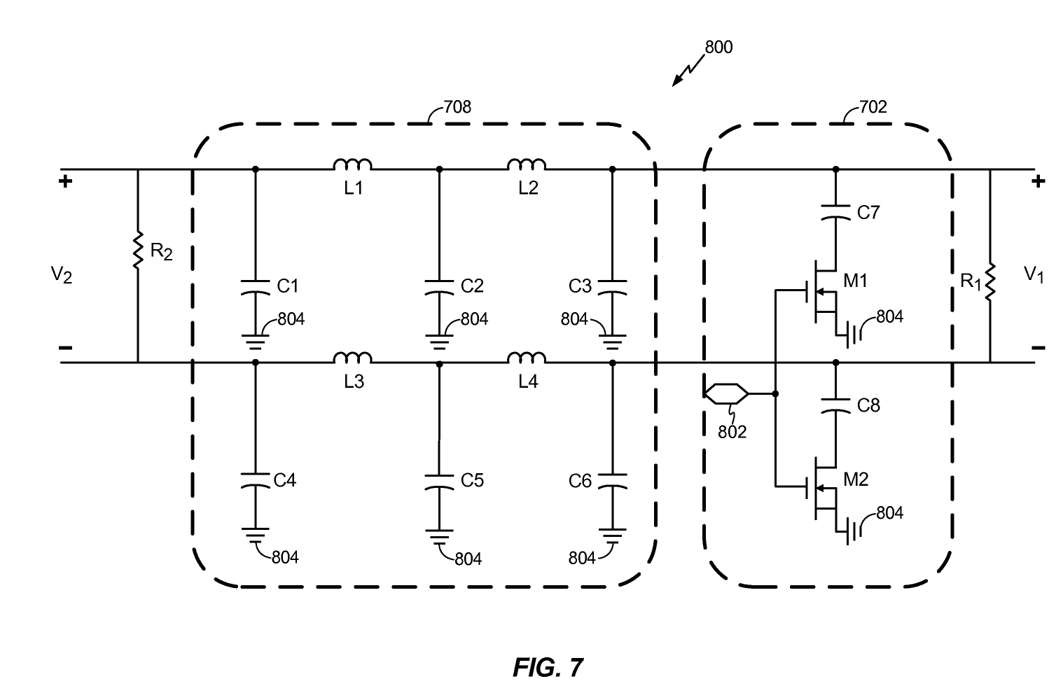

FIG. 5 illustrates a portion of transmit circuitry 700, in accordance with an exemplary embodiment of the present invention. Transmit circuit 700 includes a detuning circuit 702 and filter 708, which may comprise filter 208 illustrated in FIG. 4. As an example only, filter 708 may comprise a low-pass filter and, more specifically, a 5^{th} order low-pass filter. Transmit circuitry may also include a controller 714 (e.g., controller 214 of FIG. 3), an amplifier 710 (e.g., amplifier 210 of FIG. 4), a matching circuit 706 (e.g., matching circuit 206 of FIG. 4) and a transmit coil 704, which may comprise transmit antenna 204 of FIG. 4. Although FIG. 7 illustrates detuning circuit 702 coupled between low pass filter 708 and transmit coil 704, embodiments of the present invention are not so limited. Rather, as one example illustrated in transmit circuitry 700′ of FIG. 6, low pass filter 708 may be coupled between detuning circuit 702 and transmit coil 704. In an exemplary embodiment wherein filter 708 is positioned between detuning circuit 702 and transmit coil 704, noise generated by detuning circuit may be filtered by filter 708.

FIG. 7 illustrates a circuit 800 including filter 708 and detuning circuit 702, according to an exemplary embodiment of the present invention. It is noted that a voltage V1, which is across resistor R1, may comprise either an input voltage or an output voltage. Similarly, a voltage V2, which is across resistor R2, may comprise either an input voltage or an output voltage. Accordingly, when voltage V2 comprises an input voltage, voltage V1 comprises an output voltage. Moreover, when voltage V1 comprises an input voltage, voltage V2 comprises an output voltage. As illustrated in FIG. 7, detuning circuit 702 includes two shunt pairs, each pair comprising a reactive element (e.g., a capacitor C7 or a capacitor C8) and a transistor in series for differential drive with centre tap. As described more fully below, only a single shunt pair including a reactive element (e.g., a capacitor) and a transistor is required for a single ended system.

More specifically, with reference to FIG. 7, detuning circuit 702 includes a first transistor M1 and a second transistor M2. Each of transistor M1 and transistor M2 have a gate coupled to a control source 802. Moreover, transistor M1 and transistor M2 each have a source coupled to a ground voltage 804. Transistor M1 has a drain coupled to capacitor C7 and transistor M2 has a drain coupled to capacitor C8. It is noted that capacitors C7 and C8 may comprise any suitable capacitance and, furthermore, the values of capacitors C7 and C8 may be selected to control the loss of circuit 800. As one example, capacitor C7 and capacitor C8 may each have a capacitance of 470 pF. As another example, each of capacitor C7 and capacitor C8 may have a capacitance of 1000 pF. As illustrated in FIG. 7, filter 708 also comprises capacitors C1-C6 and inductors L1-L4.

It is noted that while both transistor M1 and transistor M2 are in a non-conductive state, filter 708 may function as a low pass filter. Further, any additional parasitic capacitance may be merged into capacitors C3 and C5 without much or any impact in efficiency and tuning. Moreover, if both transistor M1 and transistor M2 are in a conductive state, the last shunt reactive element of the low pass filter may become either the summation of capacitor C3 and capacitor C7 or the summation of capacitor C5 and capacitor C8, which may degrade the pass band of filter or detune circuit 800, thus detuning an associated transmitter.

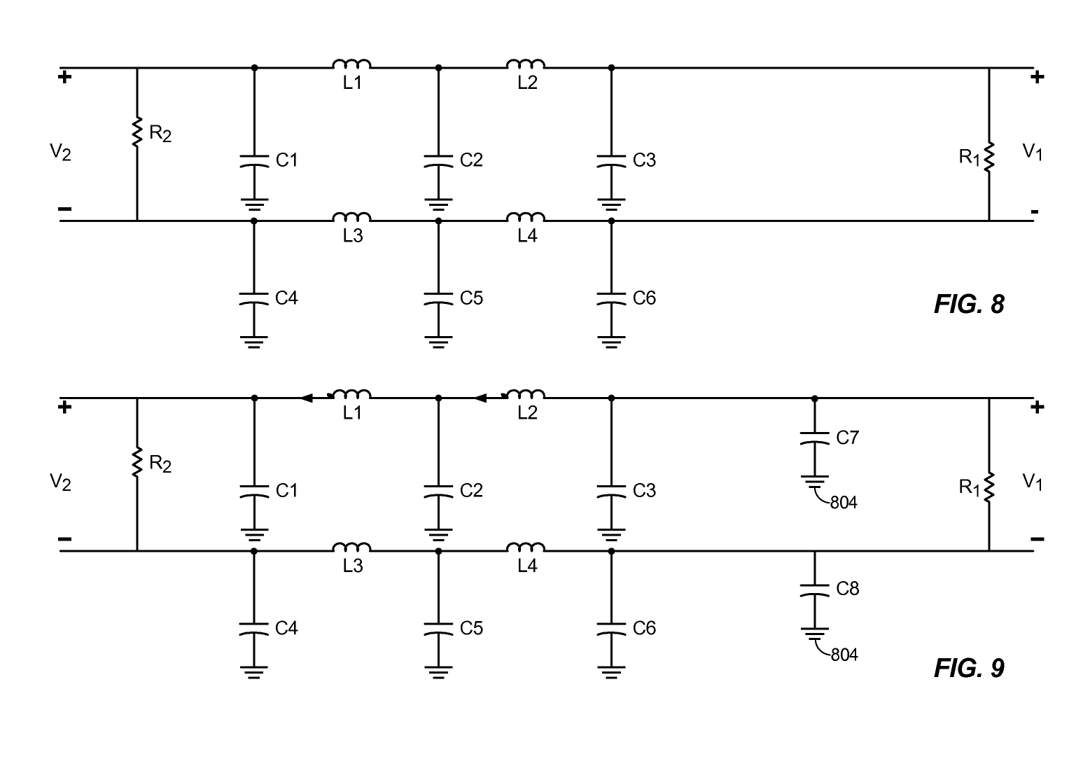

FIG. 8 illustrates circuit 800 while transistor M1 and transistor M2 are in a non-conductive state. FIG. 9 illustrates circuit 800 while transistor M1 and transistor M2 are in a fully conductive state. Accordingly, as will be appreciated by a person having ordinary skill in the art, in an embodiment wherein voltage V1 comprises an input voltage and voltage V2 comprises an output voltage, the output voltage in FIG. 9 (i.e., voltage V2) will be less than the output voltage (i.e., voltage V2) in FIG. 8. Furthermore, in an embodiment wherein voltage V2 comprises an input voltage and voltage V1 comprises an output voltage, the output voltage in FIG. 9 (i.e., voltage V1) will be less than the output voltage (i.e., voltage V1) in FIG. 8.

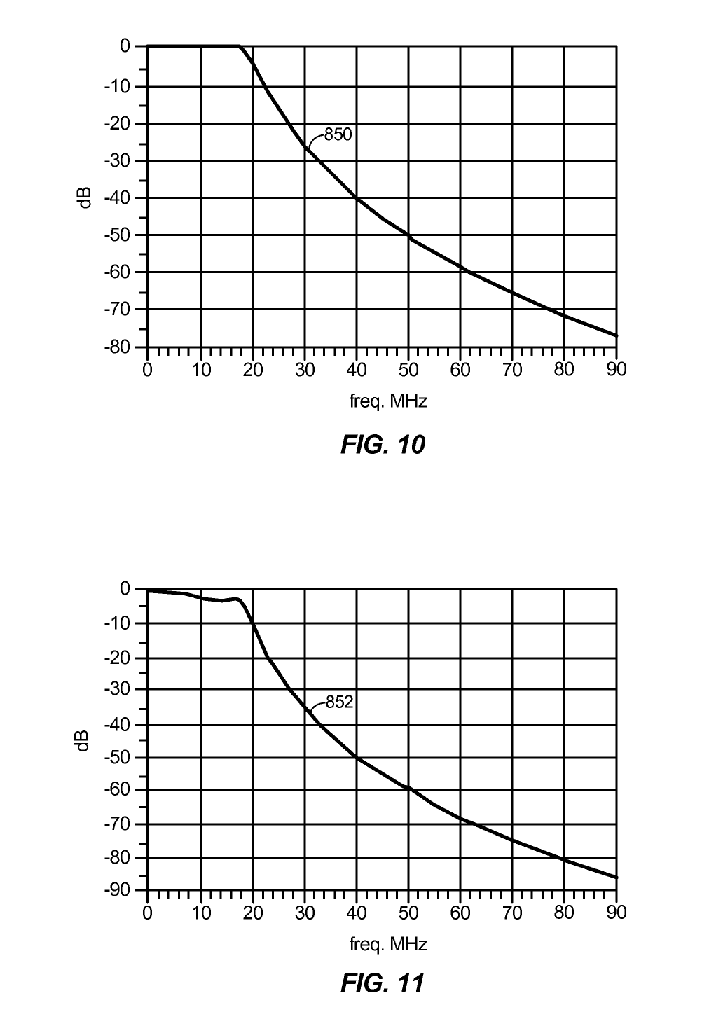

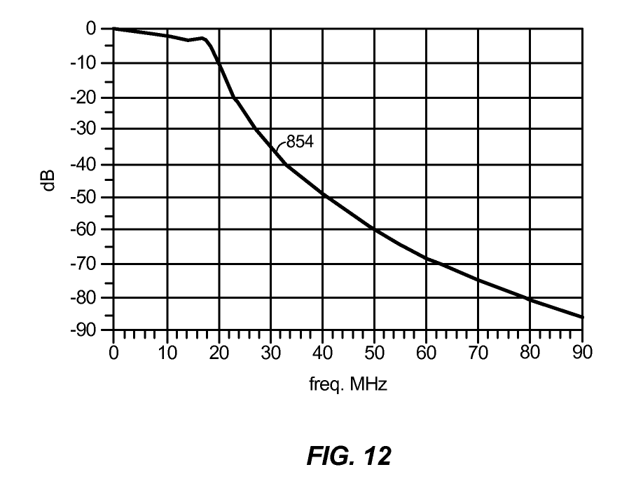

FIG. 10 illustrates a response 850 of circuit 800 with both transistor Ml and transistor M2 in a non-conductive state. FIG. 11 illustrates a response 852 of circuit 800 wherein each of transistor M1 and transistor M2 are in a fully conductive state and capacitor C7 and C8 each have a capacitance value of 470 pF. FIG. 12 illustrates a response 854 of circuit 800 wherein each of transistor M1 and transistor M2 are in a fully conductive state and capacitor C7 and C8 each have a capacitance value of 1000 pF. By turning on one or more of transistor M1 and transistor M2, the pass band of circuit 800 may be degraded while the rejection band of circuit 800 is maintained, thus reducing the output power of circuit 800. Furthermore, as noted above, the loss of circuit 800 may be further controlled by selecting an appropriate capacitance value for each of capacitors C7 and C8. Accordingly, in comparison to response 850 illustrated in FIG. 10, response 852 illustrated in FIG. 11 (i.e., wherein capacitor C7 and capacitor C8 each have a capacitance value of 470 pF) has a 3 dB loss at 13.56 MHz, and response 854 illustrated in FIG. 12 (i.e., wherein capacitor C7 and capacitor C8 each have a capacitance value of 1000 pF) has a 7 dB loss at 13.56 MHz.

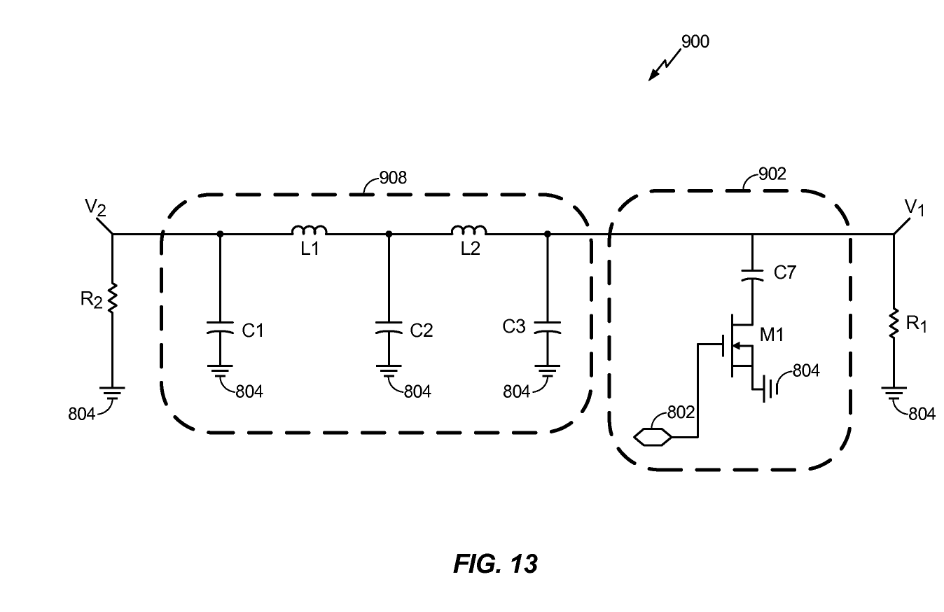

As noted above, only a single shunt pair including a capacitor and a transistor may be required for a single ended system. FIG. 13 illustrates a single ended system 900 including a detuning circuit 902 and a filter 908. Detuning circuit 902 includes transistor M1 having a gate coupled to control source 802 and a source coupled to ground voltage 804. Further, transistor M1 has a drain coupled to capacitor C7. As noted above with respect to circuit 800 in FIG. 7, voltage V1, which is across resistor R1, may comprise either an input voltage or an output voltage. Similarly, voltage V2, which is across resistor R2, may comprise either an input voltage or an output voltage. Accordingly, when voltage V2 comprises an input voltage, voltage V1 comprises an output voltage. Moreover, when voltage V1 comprises an input voltage, voltage V2 comprises an output voltage. As illustrated in FIG. 13, filter 908 also comprises capacitors C1-C3 and inductors L1 and L2.

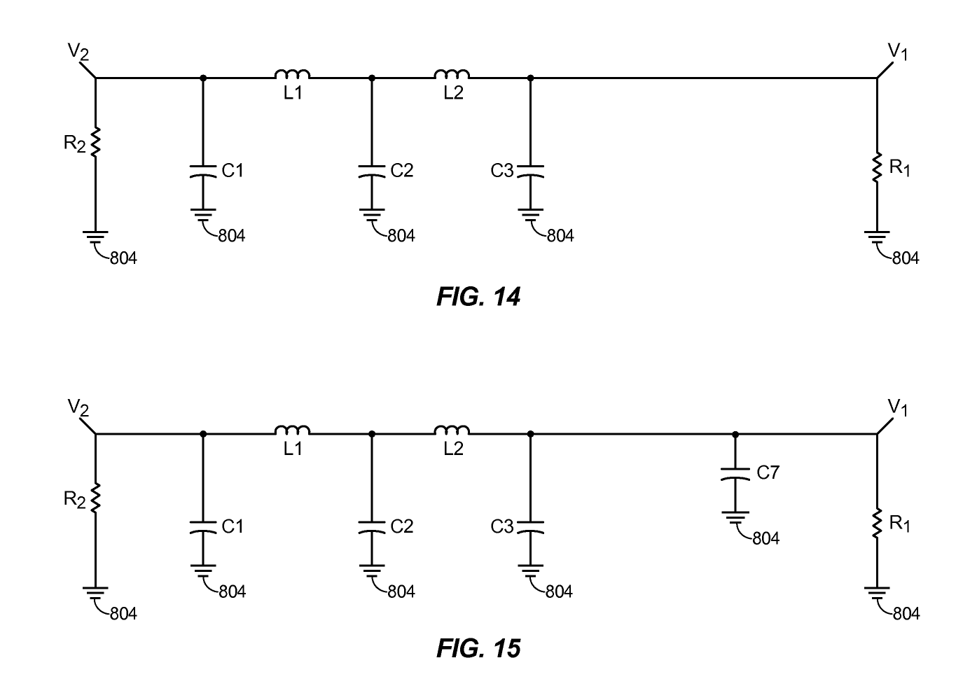

FIG. 14 illustrates single ended system 900 while transistor M1 is in a non-conductive state. FIG. 15 illustrates single ended system 900 while transistor M1 is in a fully conductive state. Accordingly, as will be appreciated by a person having ordinary skill in the art, in an embodiment wherein voltage V1 comprises an input voltage and voltage V2 comprises an output voltage, the output voltage in FIG. 15 (i.e., voltage V2) will be less than the output voltage (i.e., voltage V2) in FIG. 14. Furthermore, in an embodiment wherein voltage V2 comprises an input voltage and voltage V1 comprises an output voltage, the output voltage in FIG. 15 (i.e., voltage V1) will be less than the output voltage (i.e., voltage V1) in FIG. 14.

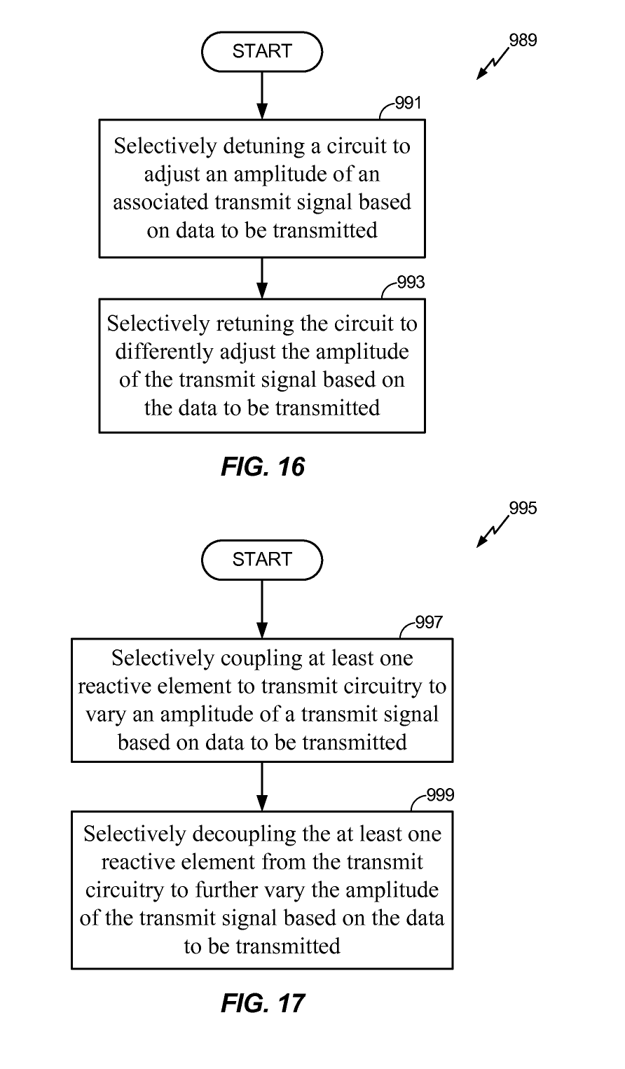

FIG. 16 is a flowchart illustrating another method 989, in accordance with one or more exemplary embodiments. Method 989 may include selectively selectively detuning a circuit to adjust an amplitude of an associated transmit signal based on data to be transmitted (depicted by numeral 991). Method 989 may further include selectively retuning the circuit to differently adjust the amplitude of the transmit signal based on the data to be transmitted (depicted by numeral 993).

FIG. 17 is a flowchart illustrating another method 995, in accordance with one or more exemplary embodiments. Method 995 may include selectively coupling at least one reactive element to transmit circuitry to vary an amplitude of a transmit signal based on data to be transmitted (depicted by numeral 997). Method 995 may further include selectively decoupling the at least one reactive element from the transmit circuitry to further vary the amplitude of the transmit signal based on the data to be transmitted (depicted by numeral 999).

In comparison to prior art methods that utilize buck converters, the exemplary embodiments described herein may be faster, cheaper, or both. More specifically, various exemplary embodiments of the invention described herein may enable for faster signaling speed and thus higher data rates due to faster response time. It is noted that the exemplary embodiments described herein may be configured to signal at a rate of ten to twenty times faster than a power converter, such as a buck converter. Therefore, if implemented within a wireless charging system, circuit 800 or circuit 900 may reduce the signaling window for the wireless power system, which may improve charging times of the wireless power system. Additional, compared to conventional methods and systems, the exemplary embodiment of the present invention may decrease glitches or ringing of a transmit signal. Furthermore, it is noted that the detuning circuits described herein may not affect the pass band frequency of an associated filter.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A method, comprising:
selectively detuning a circuit to adjust an amplitude of an associated transmit signal based on data to be transmitted; and
selectively retuning the circuit to differently adjust the amplitude of the transmit signal based on the data to be transmitted.

2. The method of claim 1, wherein selectively detuning a circuit comprises selectively coupling at least one reactive element to the circuit to decrease the amplitude of the transmit signal.

3. The method of claim 2, wherein selectively coupling the at least one reactive element to the circuit comprises causing at least one transistor to conduct to selectively couple the at least one reactive element to the circuit.

4. The method of claim 1, further comprising filtering the transmit signal.

5. The method of claim 4, wherein filtering the transmit signal comprises filtering the transmit signal with a 5^{th} order low-pass filter.

6. The method of claim 1, wherein selectively retuning the circuit comprises selectively decoupling at least one reactive element from the circuit to increase the amplitude of the transmit signal.

7. A method, comprising:
selectively coupling at least one reactive element to transmit circuitry to vary an amplitude of a transmit signal based on data to be transmitted; and
selectively decoupling the at least one reactive element from the transmit circuitry to further vary the amplitude of the transmit signal based on the data to be transmitted.

8. The method of claim 7, wherein selectively coupling at least one reactive element to transmit circuitry comprises causing at least one transistor to couple the at least one reactive element to the transmit circuitry.

9. The method of claim 7, wherein selectively coupling at least one reactive element to transmit circuitry to vary the amplitude of the transmit signal comprises decreasing the amplitude of the transmit signal by selectively coupling at least one reactive element to transmit circuitry.

10. The method of claim 7, wherein selectively decoupling the at least one reactive element from the transmit circuitry to vary the amplitude of the transmit signal comprises increasing the amplitude of the transmit signal.

11. The method of claim 7, further comprising filtering the signal.

12. The method of claim 11, wherein filtering the signal comprises filtering the signal with a low pass filter.

13. A transmitter, comprising:
a filter configured to couple to a transmit signal on one of an input and an output; and
a detuning circuit coupled to one of the input and the output and configured to selectively adjust an amplitude of the transmit signal.

14. The transmitter of claim 13, wherein the detuning circuit is coupled to the input of the filter.

15. The transmitter of claim 13, wherein detuning circuit is coupled to the output of the detuning circuit.

16. The transmitter of claim 13, wherein the detuning circuit comprises at least one capacitor coupled to a transistor.

17. The transmitter of claim 13, wherein the detuning circuit is configured to reduce a magnitude of the signal by coupling at least one capacitor to associated transmit circuitry.

18. The transmitter of claim 13, wherein the detuning circuit is configured to increase a magnitude of the signal by decoupling at least one capacitor from associated transmit circuitry.

19. A transmitter, comprising:
transmit circuitry including:
a detuning component configured to attenuate an signal; and
a filter operably coupled to the detuning component and configured to filter the signal; and
a transmit antenna configured to wirelessly transmit the signal.

20. The transmitter of claim 19, wherein the detuning component includes at least one capacitor selectively coupled to the transmit circuitry.

21. The transmitter of claim 20, wherein the detuning component is configured to decrease a magnitude of the signal by coupling the at least one capacitor to the transmit circuitry.

22. The transmitter of claim 20, wherein the detuning component is configured to increase a magnitude of the signal by decoupling the at least one capacitor from the transmit circuitry.

23. The transmitter of claim 20, wherein the detuning circuit comprises at least one transistor configured to conduct and cause the at least one capacitor to couple to the transmit circuitry.

24. The transmitter of claim 23, wherein a gate of the at least one transistor is configured to receive a control signal.

25. The transmitter of claim 19, wherein an output of the detuning component is coupled to an input of the filter.

26. The transmitter of claim 19, wherein the filter comprises a low pass filter.

27. A device, comprising:
means for selectively coupling at least one reactive element to transmit circuitry to vary an amplitude of a transmit signal based on data to be transmitted; and
means for selectively decoupling the at least one reactive element from the transmit circuitry to further vary the amplitude of the transmit signal based on the data to be transmitted.

28. The device of claim 27, wherein the device further comprises means for decreasing the amplitude of the transmit signal by selectively coupling the at least one reactive element to the transmit circuitry.

29. The device of claim 27, wherein the device further comprises means for increasing the amplitude of the transmit signal by selectively decoupling the at least one reactive element from the transmit circuitry.

30. A device, comprising:
means for selectively detuning a circuit to adjust an amplitude of an associated transmit signal based on data to be transmitted; and
means for selectively retuning the circuit to differently adjust the amplitude of the transmit signal based on the data to be transmitted.

31. The device of claim 30, wherein the device further comprises means for selectively decoupling at least one reactive element from associated transmit circuitry to tune the circuit and increase the amplitude of the transmit signal.

32. The device of claim 30, wherein the device further comprises means for selectively coupling at least one reactive element to associated transmit circuitry to detune the circuit and decrease the amplitude of the transmit signal.
